(19) United States
(12) Patent Application Publication
(10) Pub. No.: US 2020/0300708 A1
(43) Pub. Date: Sep. 24, 2020

(54) METHOD AND SYSTEM FOR MEASURING THE TEMPERATURE OF A MOVING STRIP

(71) Applicant: TATA STEEL IJMUIDEN B.V., VELSEN-NOORD (NL)

(72) Inventors: Johan WULLINK, HEEMSKERK (NL); Christiaan Louis Augustinus DELICAAT, SINT PANCRAS (NL); Erwin SPELBOS, UITGEEST (NL)

(73) Assignee: TATA STEEL IJMUIDEN B.V., VELSEN-NOORD (NL)

(21) Appl. No.: 16/754,977

(22) PCT Filed: Oct. 19, 2018
(86) PCT No.: PCT/EP2018/078696

§ 371 Date: Apr. 9, 2020

(30) Foreign Application Priority Data
Dec. 11, 2017 (EP) 17206515.3
Mar. 9, 2018 (EP) 18160976.9

(51) Int. Cl. G01J 5/00; G01J 5/22; G01J 5/08; B21B 38/00; G01J 5/50

(52) U.S. Cl. CPC G01J 5/0044; G01J 5/0022; G01J 5/505; G01J 5/08; B21B 38/006; G01J 5/22

(57) ABSTRACT

A method for measuring the temperature of a moving strip, wherein the strip is in contact with a roll such that a wedge is present between the strip and the roll where the strip and the roll depart and a wedge is present between the strip and the roll where the strip and the roll meet. The temperature of the strip is measured along at least part of the length of at least one of the wedges using an infrared or visible light measuring camera. A system for measuring the temperature of a moving strip.

The invention relates to a method for measuring the temperature of a moving strip, wherein the strip is in contact with a roll such that a wedge shaped opening is present between the strip and the roll where the strip and the roll depart and a wedge shaped opening is present between the strip and the roll where the strip and the roll meet. The invention also relates to a system for measuring the temperature of a moving strip using the method.

Measuring the temperature of a moving strip is important to control the properties of a strip. This measurement is for instance performed in the annealing furnace in which a full-hard cold rolled steel strip is annealed and optionally thereafter hot dip coated, for instance with zinc or a zinc alloy, or with aluminium or an aluminium alloy. The temperature during annealing is important to provide certain properties to the annealed strip, and the temperature of the strip is also important to control the entry temperature of the strip into the hot dip bath. Also the temperature of the strip after hot dip coating is important for certain steel grades.

At present two types of temperature measurements are known to measure the temperature of a steel strip in an annealing furnace, wherein the temperature of the strip at the place of measurement is usually above 300° C.

The temperature of a moving strip can be measured at any place using a scanning pyrometer. Infrared radiation coming from the surface of the strip is collected by using a rotating mirror. The radiation from the strip is reflected in this mirror and focussed on a single point detector. In this way, the temperature of the strip is measured over its full width. However, the emissivity of the strip is rather low in comparison to the emissivity of a black body, dependant on for example the presence of oxide. Moreover, the emissivity of the strip having a certain temperature depends on the steel type of the strip. Advanced High Strength Steels have an emissivity that is different from standard low carbon steels, such as IF steel. Furthermore, the measurement of the temperature of the strip is influenced by the hot walls of the annealing furnace in which the strip is measured. The radiation of the walls reflects on the strip and is measured as if it is the radiation of the strip itself. To prevent the radiation of the walls to be measured, the part of the surface of the strip that is to be measured is shielded by for example a water-cooled cone that is placed between the scanning pyrometer and the strip. The cone should have a low temperature, which is established by feeding tapping water through the double walls of the cone. The top of the cone is just outside the furnace and the scanning pyrometer is mounted on top of this cone. This construction has the risk that cooling water leaks into the furnace, which is absolutely forbidden. Moreover, such a construction is not easy to install, and costly.

Usually the temperature of an object is measured with a spot pyrometer. The basic set-up of such a spot pyrometer measurement is by pointing the spot pyrometer perpendicularly to the surface of for example a moving strip. The disadvantage of this method is that the temperature measurement result is dependent on the emissivity of the strip surface, and so a changing emissivity because a different steel grade is processed will cause a measurement error. It is known to measure the temperature of the steel in a wedge shaped opening between a roll and the moving strip, for instance from KR970010936B. According to the abstract of this document, the steel strip is cold. However, it is also known to use a ‘radiation thermometer’ for measuring the temperature of the moving strip in general in the wedge shaped opening, for instance from JP2000186962. The temperature of the strip in the wedge shaped opening is measured because in the wedge shaped opening the emissivity of the steel strip is not affected by infrared radiation noise from the surrounding, and the emissivity is almost the emissivity of a black body, so the emissivity value is close to unity.

However, the use of a pyrometer or radiation thermometer has the disadvantage that only one spot on the strip in the wedge shaped opening is measured. Furthermore, it is difficult to keep the measuring spot of the pyrometer always positioned at the wedge shaped opening, because the pyrometer is attached to one of the walls of the furnace. Because the furnace is heated and cooled in the course of time, the position of the pyrometer spot may shift.

It is an object of the invention to provide a method for measuring the temperature of a moving strip that is an improvement over the known measuring methods.

It is a further object of the invention to provide a method for measuring the temperature of a moving strip that can measure the temperature of the strip over at least part of its width, preferably over the full width of the strip.

It is another object of the invention to provide a method for measuring the temperature of a moving strip that measures the temperature of the strip with a deviation of at most 10° C.

It is furthermore an object of the invention to provide a method for measuring the temperature of a moving strip that is relatively easy to control.

It is moreover an object of the invention to provide a system for measuring the temperature of a moving strip.

According to the invention, one or more of these objects are reached by using a method for measuring the temperature of a moving strip, wherein the strip is in contact with a roll such that a wedge shaped opening is present between the strip and the roll where the strip and the roll depart and a wedge shaped opening is present between the strip and the roll where the strip and the roll meet, and wherein the temperature of the strip is measured along at least part of the length of at least one of the wedge shaped openings using an infrared or visible light measuring camera.

Using an infrared or visible light camera for measuring the temperature of the strip in the wedge shaped opening instead of a pyrometer has the advantage that the temperature of at least a part of the width of the strip can be measured. The use of an infrared or visible light camera is advantageous over the use of a scanning pyrometer in that no moving parts are needed and in that a more accurate measurement is possible. Moreover, an infrared or visible light camera is less expensive in comparison to a scanning pyrometer.

In certain cases the full width of the strip can be measured with one camera. This can be in particular the case when the temperature of the strip is low, that is the temperature of the strip is at room temperature or slightly above, and it is easy to position the camera in front of the wedge shaped opening.

The use of an infrared or visible light camera has moreover the advantage that a 2D image is provided by the camera. The camera thus provides an image of the wedge shaped opening and its surroundings, thereby making it possible to detect shape defects of the strip like wavy edges or to detect surface defects or other changes on the surface of the strip due to a change in emissivity at that part of the strip.

A wedge shaped opening is present between a roll and a strip at the line where the strip departs from the roll, thus at the line where the strip separates from the roll, but also at the line where the strip makes first contact with the roll, thus where the strip and the roll meet. For both types of wedge shaped openings the method according to the invention can be used, be it that at the wedge shaped opening where the strip separates from the roll the temperature of the roll will be closer to the temperature of the strip than at the entrance side of the roll, especially at higher temperatures. Consequently, the temperature measurement on the side of the roll where strip and roll separate will be more accurate than on the side where strip and roll make first contact. Two infrared or visible light cameras are used, preferably one at each end of the roll. In this way each camera can be positioned on a side of a tunnel through which the strip moves, and each camera can measure part of the wedge shaped opening opposite to the side where the camera is positioned. Using one camera makes it difficult to measure the temperature in the wedge shaped opening because the camera should be positioned far from the wedge shaped opening.

The two infrared of visible light cameras together measure at least the total length of the wedge shaped opening between the strip and the roll. In this way the temperature of the strip is measured over its full width.

Using the above method, preferably the two infrared or visible light cameras each measure more than one half of the wedge shaped opening, such that halfway the wedge shaped opening the cameras both measure the same part of the wedge shaped opening. Now the measurement of both cameras overlaps, the functioning of the cameras can be controlled by comparing the measurement values in the overlapping region.

Preferably the strip is a metal strip, more preferably a steel strip. The method according to the invention can be used outside the metal industry, such as in the production of a heated plastic web, but will be especially important for the metal industry. The method can for instance be used in the production of aluminium strip, but can be used very well in the production of steel strip, wherein the strip needs to be heated to significant temperatures, and cooled thereafter.

According to a preferred embodiment the strip has a temperature above room temperature, preferably a temperature between 50° C. and 2000° C., more preferably between 50° C. and 1200° C. It will be possible to measure the temperature of the strip in a wedge shaped opening at room temperature or below using an infrared camera, but at room temperature other temperature measurement methods are also possible. Thus, the method will be preferably used at a temperature above room temperature, especially at temperatures above 50° C., where other methods are not easy to use or show large deviations from the actual temperature of the strip. The method is especially useful in the range of 50° C. to 1200° C., as used in the production processes of metal strip, especially steel strip.

Preferably the strip is turned around a roll along part of the circumference of the roll, preferably over an angle of at least 45°, more preferably over an angle of at least 90°. Especially for higher temperatures of the strip it is important that the contact length of the strip against the roll is long enough, because the roll should obtain a temperature that is almost the same as the temperature of the strip. In this way, the temperature in the wedge shaped opening where the strip and the roll depart is almost the same as the temperature of the strip, and thus the camera can measure the temperature of the strip accurately.

According to a preferred embodiment the visible light camera is a digital camera, preferably having a matrix sensor holding at least 640×480 pixels. A digital camera is a standard camera that is robust and provides enough detailed information about the wedge shaped opening and the surroundings of the wedge shaped opening when the matrix sensor has 640×480 pixels. The digital camera can for instance be a CMOS camera.

According to another preferred embodiment the infrared camera is a near infrared camera, short-wavelength infrared camera, mid-wavelength infrared camera or long-wavelength infrared camera measuring infrared wavelength between 0.8 and 12 μm, preferably a mid-wavelength infrared camera measuring infrared wavelength between 3 and 5 μm. Such an infrared camera can measure the temperatures of the wedge shaped opening that are lower than those for which the visible light camera is used. A mid-wavelength infrared camera can measure temperatures well between approximately 50° C. and 500° C., a long-wavelength camera can measure even lower temperatures.

When the strip is a metal strip the method according to the invention can be advantageously used when the roll is part of a furnace, preferably an annealing furnace, more preferably an annealing furnace coupled to a hot dip coating line. In furnaces it is important to know what the temperature of the strip is, so the furnace can be controlled such that the strip has the required temperature. This is especially important in an annealing furnace, where the strip has to have different temperatures at different points in the annealing furnace. This is also the case when a steel strip is coated in a hot dip coating line, both before the strip is coated and after the coating has been applied.

Preferably a control system detects the position of the wedge shaped opening in an image generated by the camera and based on this position of the wedge shaped opening the control system can measure the temperature in the wedge shaped opening. The use of an infrared or visible light camera has the advantage that a 2D image is provided by the camera and that by means of a control system the exact position of the wedge shape opening can be found. In this way there is no critical pointing of the camera towards the wedge shape opening needed, because if the image is shifted caused by heating and cooling of for instance the furnace wall, this control system will find the shifted position of the wedge shape opening.

According to a second aspect of the invention a system for measuring the temperature of a moving strip is provided, using the method for measuring the temperature of the strip according to the first aspect of the invention as described above, wherein a roll is available which during use is in contact with the moving strip such that a wedge shape opening is present between the strip and the roll where the strip and the roll depart and a wedge shaped opening is present between the strip and the roll where the strip and the roll meet, and wherein an infrared or visible light measuring camera is installed such that the camera faces one of the wedge shaped openings to measure the temperature of the strip along at least part of the length of that wedge shaped opening.

The use of an infrared or visible light measuring camera makes it possible to accurately measure the temperature of the strip in the wedge shaped opening over at least a part of the length of the wedge shaped opening.

According to a preferred embodiment the visible light camera is a digital camera, preferably having a matrix sensor holding at least 640×480 pixels, or the infrared camera is an infrared camera measuring infrared wavelength between 0.8 and 12 μm, preferably a mid-wavelength infrared camera measuring infrared wavelength between 3 and 5 μm. With the digital camera strips having a relatively high temperature can be measured, and with the mid-wavelength infrared camera strips having a relatively low temperature can be measured. The digital camera is for instance a CMOS camera.

According to a preferred embodiment two infrared or visible light cameras are used, preferably each at one end of the roll. The advantages are elucidated above.

Preferably the roll is part of a furnace, more preferably an annealing furnace, even more preferably an annealing furnace coupled to a hot dip coating line. In a furnace, the two cameras can be positioned on or in the sidewalls of the furnace such that each camera can measure the opposite half of the wedge shaped opening. Positioned in this way, the openings through the walls of the furnace through which the cameras measure are easier to make since these openings are less oblique.

Other aspects of the system for measuring the temperature of a moving strip will be readily apparent from the description of the method according to the invention, above.

The invention will be elucidated with reference to an embodiment of a system for measuring the temperature of a moving strip.

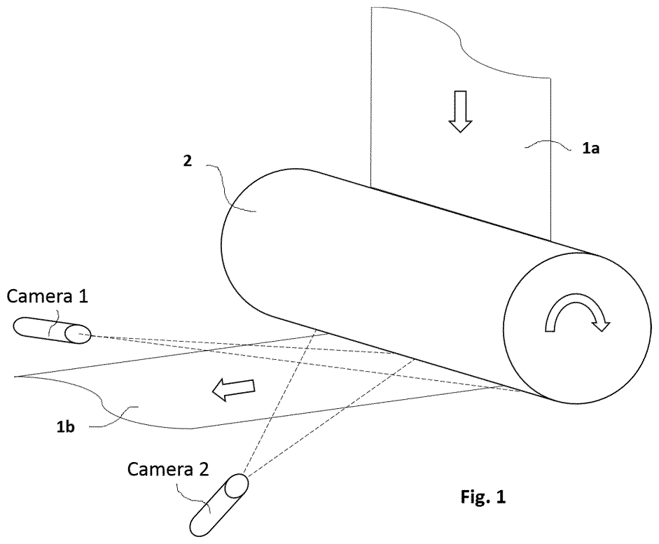

FIG. 1 shows, in a very schematic way, a system for measuring the temperature of a moving strip according to the invention.

FIG. 1 shows a section of a moving strip 1, of which a first part 1a is moving towards a roll 2, which roll is rotating in the direction of the curved arrow. A second part 1b of the moving strip 1 departs from the rotating roll 2.

The moving strip 1 is turned around the roll 2 over an angle of about 90 degrees and is thus deflected from a vertical position of first part 1a to a horizontal position of second part 1b. At the line where the first part 1a meets the roll 2, a wedge shaped opening is present between the strip 1 and the roll 2. In the same way, at the line where the strip 1 separates from the roll 2, a wedge shaped opening is present between the roll 2 and the strip 1.

In the specific situation for the measuring of the temperature of a steel strip in an annealing furnace, the roll 2 will be part of the annealing furnace; the roll will be present between walls (not shown) of this annealing furnace. In the annealing furnace, the strip 1 will have a temperature above room temperature, and usually the strip will have a temperature between 100 and 1000° C. Due to the temperature of the strip, the roll will also have a higher temperature, resulting from the contact with the strip. Especially at the line where the strip 1 separates from the roll 2, the temperature of the roll 2 will be almost the same as the temperature of the strip 1. For this reason, the measuring of the temperature of the strip will be performed in the wedge shaped opening between the roll and the strip separating from the roll. However, according to the invention it is also possible to measure the temperature of the strip at the wedge shaped opening formed at the line of first contact between the strip and the roll.

To measure the temperature of the strip in the wedge shaped opening between the roll and the strip at the position where the strip departs from the roll, two cameras are positioned in the walls of the annealing furnace, each at one side of the roll and the departing strip, as shown in FIG. 1. Each camera is oriented such that it measures more than one half of the wedge shaped opening at the opposite side of the strip. In this way the camera can be placed less oblique in the furnace wall. The cameras are oriented such that they measure an overlapping part of the wedge shaped opening, which makes it possible to control the functioning of the cameras by comparing the measurement values in the overlapping region. The two cameras together measure the temperature of the wedge shaped opening over the full width of the strip.

When the temperature of the strip is high, for instance above 500° C., visible light cameras can be used. When the temperature of the strip is lower, infrared cameras can be used, such as mid-wavelength infrared cameras for temperatures between 50 and 500° C. For even lower temperatures long-wavelength cameras can be used.

A control system is in place to detect the position of the wedge shaped opening in an image generated by the camera. Based on the measurement of the camera, the temperature in the wedge shaped opening can be measured.

It will be clear that the above described system for measuring the temperature of a moving strip and the method to use it can be used at various positions in an annealing furnace, and that such a system can also be used in a hot dip coating line that is coupled to an annealing furnace.

However, the system for measuring the temperature of a moving strip and the method for measuring the temperature of a moving strip can also be used outside annealing furnaces, and is not only useful for steel strip, or metal strip in general, but also for other types of moving strip, especially when the strip moves at elevated temperatures. The person skilled in the art will readily contemplate the situations where the present invention can be used.

1. Method for measuring the temperature of a moving strip, wherein the strip is in contact with a roll such that a wedge shaped opening is present between the strip and the roll where the strip and the roll depart and a wedge shaped opening is present between the strip and the roll where the strip and the roll meet, wherein the temperature of the strip is measured along at least part of the length of at least one of the wedge shaped openings using an infrared or visible light measuring camera, wherein two infrared or visible light cameras are used, one at each end of the roll, and wherein the two infrared or visible light cameras together measure at least the total length of the wedge shaped opening between the strip and the roll.

2. The method according to claim 1, wherein the two infrared or visible light cameras each measure more than one half of the wedge shaped opening, such that halfway the wedge shape opening the cameras both measure the same part of the wedge shaped opening.

3. The method according to claim 1, wherein the strip is a metal strip.

4. The method according to claim 1, wherein the strip has a temperature between 50° C. and 1200° C.

5. The method according to claim 1, wherein the strip is turned around a roll along part of the circumference of the roll, over an angle of at least 45°.

6. The method according to claim 1, wherein the infrared camera is a near infrared camera, short-wavelength infrared camera, mid-wavelength infrared camera or long-wavelength infrared camera measuring infrared wavelength between 0.8 and 12 μm.

7. The method according to claim 1, wherein the roll is part of an annealing furnace coupled to a hot dip coating line.

8. The method according to claim 1, wherein a control system detects the position of the wedge shaped opening in an image generated by the camera and based on this position of the wedge shaped opening the control system can measure the temperature in the wedge shaped opening.

9. A system for measuring the temperature of a moving strip, wherein the strip is in contact with a roll during use, such that a wedge shaped opening is present between the strip and the roll where the strip and the roll depart and a wedge shaped opening is present between the strip and the roll where the strip and the roll meet, wherein the temperature of the strip is measured along at least part of the length of at least one of the wedge shaped openings using an infrared or visible light measuring camera wherein two infrared or visible light cameras are used, one at each end of the roll, and wherein the two infrared or visible light cameras together measure at least the total length of the wedge shaped opening between the strip and the roll.

10. The system according to claim 9, wherein the two infrared or visible light cameras each measure more than one half of the wedge shaped opening, such that halfway the wedge shape opening the cameras both measure the same part of the wedge shaped opening.

11. The system according to claim 9, wherein the strip is a metal strip.

12. The system according to claim 9, wherein the strip has a temperature between 50° C. and 1200° C.

13. The system according to claim 9, wherein the infrared camera is a near infrared camera, short-wavelength infrared camera, mid-wavelength infrared camera or long-wavelength infrared camera measuring infrared wavelength between 0.8 and 12 μm.

14. The system according to claim 9, wherein the roll is part of an annealing furnace coupled to a hot dip coating line.
